(19) United States
(12) Patent Application Publication
(10) Pub. No.: US 2004/0093875 A1
(43) Pub. Date: May 20, 2004

(54) Process for converting a methane-rich vapor at one pressure to methane-rich vapor at a higher pressure

(76) Inventors: Moses Minta, Sugar Land, TX (US); Ronald R. Bowen, Magnolia, TX (US)

Correspondence Address: Marcy M. Hoefling, ExxonMobil Upstream Research Company, P.O. Box 2189, Houston, TX, 77252-2189, US

(21) Appl. No.: 10/663,267

(22) Filed: Sep. 16, 2003

Related U.S. Application Data
(60) Provisional application No. 60/427,436, filed on Nov. 19, 2002.

(51) Int. Cl. F17C 9/02; F17C 13/00

(52) U.S. Cl. 62/50.2; 62/50.6

(57) ABSTRACT

A process is provided for converting a pressurized methane-rich vapor at a first pressure to a predetermined second pressure higher than the first pressure. A pressurized liquid rich in methane is passed to an eductor to provide the motive energy for driving the eductor. The methane-rich vapor is passed to the eductor and mixed with the liquid.

This application claims the benefit of U.S. Provisional Application No. 60/427,436, filed Nov. 19, 2002.

### FIELD OF THE INVENTION

The invention relates to a process for converting a methane-rich vapor at one pressure to a higher-pressure, methane-rich vapor.

### BACKGROUND OF THE INVENTION

Because of its clean burning qualities and convenience, natural gas has become widely used in recent years. Many sources of natural gas are located in remote areas, great distances from any commercial markets for the gas. Sometimes a pipeline is available for transporting produced natural gas to a commercial market. When pipeline transportation is not feasible, produced natural gas is often processed into liquefied natural gas (which is called “LNG”) for transport to market.

It has been proposed to transport natural gas at temperatures above −112° C. (−170° F.) and at pressures sufficient for the liquid to be at or below its bubble point temperature. This pressurized liquid natural gas is referred to as “PLNG” to distinguish it from LNG, which is transported at near atmospheric pressure and at a temperature of about −162° C. (−260° F.). The term “bubble point” means the temperature and pressure at which a liquid begins to convert to gas. For example, if a certain volume of PLNG is held at constant pressure, but its temperature is increased, the temperature at which bubbles of gas begin to form in the PLNG is the bubble point at that pressure. Similarly, if a certain volume of PLNG is held at constant temperature but the pressure is reduced, the pressure at which gas begins to form defines the bubble point pressure at that temperature. At the bubble point, the liquefied gas is saturated liquid. For most natural gas compositions, the bubble point pressure of the natural gas at temperatures above −112° C. will be above 1,380 kPa (200 psia).

If PLNG is unloaded from a container, the vapor remaining in the container (“boil-off vapor”) will contain a significant mass percentage of the container's original cargo. Depending upon the pressure and temperature of storage and the composition of the PLNG, the boil-off vapors may constitute from about 10 to 20 percent of the mass of PLNG in the container before the liquid was removed. Many different processes have been proposed for handling boil-off vapor produced by PLNG during PLNG unloading from transportation containers. One option for recovering the boil-off vapor is to pump the vapor out of the storage container for use as a natural gas product. The horsepower required to run evacuation pumps (or compressors) is an added expense to the overall expense of a PLNG unloading process. The industry has a continuing interest in a process that decreases the horsepower requirements of making boil-off vapors available for commercial use.

### SUMMARY

The invention is a process for converting a vapor rich in methane at a first pressure to a predetermined second pressure higher than the first pressure. A pressurized liquid rich in methane is passed to an eductor to provide the motive energy for driving the eductor. The methane-rich vapor is passed to the eductor and mixed with the liquid. Before and/or after passing through the eductor, the liquid is pumped to a preselected third pressure, preferably a pressure equal to or higher than the second pressure, and more preferably a pressure slightly higher than the second pressure. After passing through the eductor, the liquid is vaporized, thereby producing a methane-rich vapor at the second pressure.

In one embodiment, a process according to this invention for converting a pressurized methane-rich vapor at a first pressure to a predetermined second pressure higher than the first pressure, comprises: (a) providing the pressurized methane-rich vapor in a first container at the first pressure; (b) withdrawing a pressurized liquid rich in methane from a second container; (c) passing the pressurized liquid of step (b) to an eductor to drive the eductor and passing the vapor to the eductor, thereby liquefying the vapor and combining the liquefied vapor with the pressurized liquid; (d) before or after step (c), pumping the pressurized liquid to a third pressure, higher than the second pressure; and then (e) heating the pressurized liquid, thereby producing a vapor at the predetermined second pressure.

In another embodiment, a process according to this invention for converting a pressurized methane-rich vapor at a first pressure to a predetermined second pressure higher than the first pressure, comprises: (a) providing the pressurized methane-rich vapor in a first container at the first pressure; (b) withdrawing a pressurized first liquid rich in methane from a second container; (c) pumping the pressurized first liquid to a third pressure, higher than the second pressure; (d) passing the pressurized first liquid of step (c) to an eductor to drive the eductor; (e) educting vapor from the first container and passing the vapor to the eductor, thereby liquefying the vapor and combining the liquefied vapor with the first liquid to form a second liquid at a pressure equal to or higher than the second pressure; and (f) heating the second liquid, thereby producing a vapor at the predetermined second pressure.

In another embodiment, a process according to this invention for converting a pressurized methane-rich vapor at a first pressure to a vapor at a predetermined second pressure higher than the first pressure, comprises: (a) providing the pressurized methane-rich vapor in a first container at the first pressure; (b) withdrawing a pressurized first liquid rich in methane from a second container; (c) passing the pressurized first liquid of step (b) to an eductor to drive the eductor; (d) educting vapor from the first container and passing the vapor to the eductor, thereby liquefying the vapor and combining the liquefied vapor with the first liquid to form a second liquid at a third pressure; (e) pumping the second liquid to substantially the second pressure; and (f) heating the second liquid, thereby producing a vapor at the predetermined second pressure. This process may further comprise passing the vapor produced in step (f) to a pipeline. In this process, the second liquid is preferably at or below its bubble point temperature.

In another embodiment, a process according to this invention for converting a pressurized methane-rich vapor at a first pressure to a predetermined second pressure higher than the first pressure, comprises: (a) providing the pressurized methane-rich vapor in a container at the first pressure; (b) withdrawing a pressurized first liquid rich in methane from the container; (c) pumping the pressurized first liquid to a third pressure, higher than the second pressure; (d) passing the pressurized first liquid of step (c) to an eductor to drive the eductor, the eductor producing a second liquid at the second pressure; (e) educting vapor from the first container and passing the vapor to the eductor, thereby causing the vapor to liquefy and be combined with the first liquid to form the second liquid; and (f) heating the second liquid, thereby producing a vapor at the predetermined second pressure.

### BRIEF DESCRIPTION OF THE DRAWINGS

The present invention and its advantages will be better understood by referring to the following detailed description and the attached drawings.

FIG. 1 schematically illustrates one embodiment of the invention in which PLNG is further pressurized prior to being introduced to an eductor.

FIG. 2 schematically illustrates a second embodiment of the invention in which PLNG is further pressurized both before and after passing through an eductor.

FIG. 3 is a sectional view showing a preferred form of the eductor used in the embodiments illustrated in FIGS. 1 and 2.

The drawings are not intended to exclude from the scope of the invention other embodiments that are the result of normal and expected modifications of these specific embodiments.

### DETAILED DESCRIPTION OF THE INVENTION

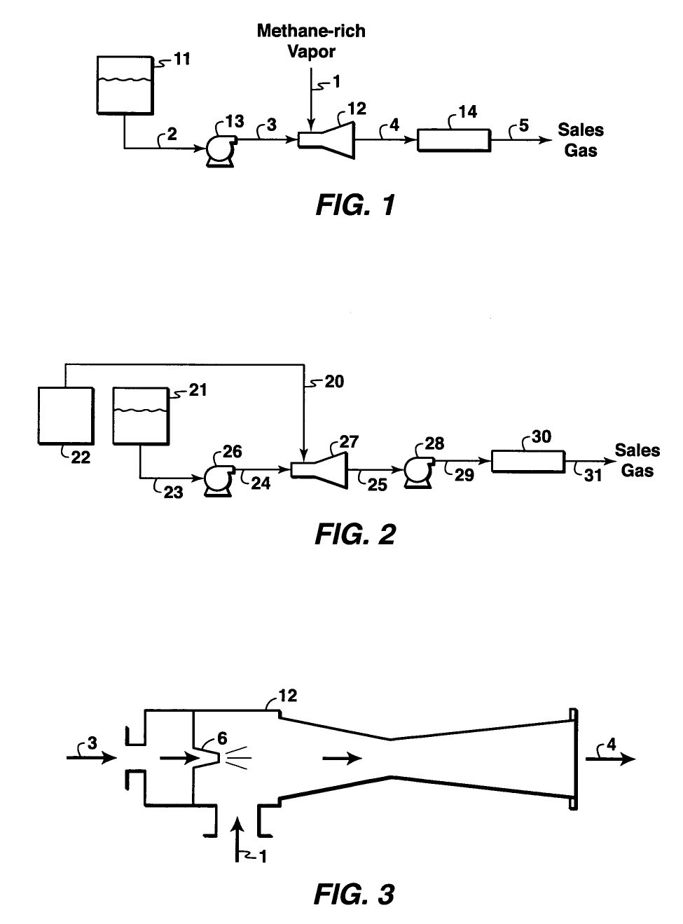

FIG. 1 schematically illustrates one embodiment for practicing the method of the present invention. Stream or conduit 1, which can be a gas transmission line, conveys a methane-rich vapor stream at a first pressure to the suction or aspiration side of a conventional venturi-type eductor 12. Pressurized liquid natural gas (“PLNG”) from container 11 is passed by stream or conduit 2 to pump 13 wherein the PLNG is further pressurized, preferably to a pressure equal to or higher than, and more preferably slightly above, the desired delivery pressure of sales gas in stream or conduit 5 to account for both pressure drop in the eductor due to thermodynamic irreversibilities of mixing and frictional pressure drop in the process between the pump 13 and the desired delivery pressure. Although FIG. 1 shows one pump 13, two or more pumps (not shown) in parallel or series may be used in for pressurizing the PLNG. From pump 13, the PLNG is passed by stream or conduit 3 to eductor 12 to provide the motive power to pressurize the lower pressure vapor supplied by stream or conduit 1. The methane-rich vapor may be from any suitable source. For example, the vapor supplied through stream or conduit 1 may be withdrawn from container 11, it may be withdrawn from a separate container that has been previously emptied of liquid natural gas, it may be withdrawn from more than one container simultaneously, or the vapor may be supplied from a pipeline, or any combination thereof.

Pump 13 sub-cools the PLNG being delivered through conduit 2 by increasing the pressure of the liquid. Sub-cooling means that the PLNG is at a temperature below its equilibrium temperature, or bubble point temperature, for a given pressure.

Eductor 12 creates a venturi effect by the PLNG passing therethrough. The methane-rich vapor passing through conduit 1 is drawn into the PLNG of stream 3. Because the mass of the sub-cooled PLNG flowing through the eductor 12 is much greater than the mass of vapor drawn through conduit 1, the methane-rich vapor will be condensed as it mixes with the PLNG to form a discharge stream that is passed through conduit 4.

Liquid in stream or conduit 4 is passed to a vaporizer 14. Vaporizer 14 can be any conventional system for vaporizing the liquefied gas, which are well known to those skilled in the art. The vaporizer 14 may for example use a heat transfer medium from an environmental source such as air, fresh water, sea water, or the PLNG in the vaporizer 14 may serve as a heat sink in a power cycle to generate electrical energy.

Although not shown in FIG. 1, one or more pumps, before or after eductor 12, or both before and after eductor 12 may be used to further increase the pressure of the PLNG. An embodiment of the present invention with pumps before and after an eductor is illustrated in FIG. 2.

FIG. 2 schematically illustrates a second embodiment of the invention in which PLNG is further pressurized after passing through an eductor. PLNG is withdrawn through conduit 23 from container 21, pumped to a higher pressure by pump 26, and passed to eductor 27 through stream or conduit 24. Boil-off vapor is withdrawn from container 22 and passed to eductor 27 through stream or conduit 20. Expansion of PLNG in eductor 27 sub-cools the PLNG, thereby causing the methane-rich vapor passed to eductor 27 through conduit 20 to be liquefied when mixed with the sub-cooled PLNG. The discharge from eductor 27 may optionally be passed through stream or conduit 25 to pump 28 for still further pressurization of the PLNG, preferably to a pressure approximating the desired pressure of the inlet to a distribution pipeline (not shown). From pump 28, the PLNG is passed through conduit 29 to a vaporizer 30 for vaporization and passed by conduit 31 to the distribution pipeline.

Whereas the present invention has been described primarily with respect to the liquefaction of natural gas and is especially suited therefor, it may also be used for pressurizing other vapors.

By means of one or more eductors, it is possible to empty storage containers of methane-rich vapor without using pumps or compressors. The fluid eductor may have multiple inlet nozzles and multiple eductors in parallel or series may be used. The one or more eductors used in the present invention can be any of various types of conventional jet pumps used to withdraw fluid materials from a space. FIG. 3 illustrates in a sectional view one example of an eductor that may be used in the embodiment illustrated in FIG. 1. Referring to FIG. 3, pressurized liquid stream passes through conduit 3 into eductor 12 and passes through nozzle 6. The venturi effect of passage through nozzle 6 causes vapor stream from conduit 1 to be sucked into the eductor 12 and to be to be mixed with the liquid being emitted from the nozzle.

### EXAMPLE

A simulated mass and energy balance was carried out to illustrate the embodiment illustrated in FIG. 2, and the results are set forth in Table 1 below. In this simulation, referring to FIG. 2, it was assumed that containers 21 and 22 were two containers of a plurality of containers on a PLNG transportation means such as a ship. The PLNG was assumed to have compositions set forth in Table 1. It was further assumed that container 22 was previously emptied of PLNG and that pressurized boil-off vapor remained in container 22. It was further assumed that container 21 was partially filled with PLNG at a temperature of −95° C. and a pressure of about 450 psia. The methane-rich vapor in container 22 was assumed to be at a temperature of −95° C. and a pressure of about 450 psia. The compositions of vapor stream 20 and liquid stream 24 are set forth in Table 1.

The data presented in Table 1 are offered to provide a better understanding of the embodiment shown in FIG. 2, but the invention is not to be construed as unnecessarily limited thereto. The temperatures and flow rates are not to be considered as limitations upon the invention which can have many variations in temperatures and flow rates in view of the teachings herein.

TABLE 1
Simulation Composition

| | | Mole Fraction Basis | | |
|---|---|---|---|---|
| | | Vapor | PLNG | Discharge |
| | | Stream | Stream | Stream |
| | | 20 | 24 | 25 |
| Methane | C₁ | 0.966261 | 0.938615 | 0.941381 |
| Ethane | C₂ | 0.003657 | 0.029847 | 0.027227 |
| Propane | C₃ | 0.000269 | 0.010925 | 0.009859 |
| i-Butane | i-C₄ | 0.000017 | 0.002230 | 0.002008 |
| n-Butane | n-C₄ | 0.000016 | 0.003054 | 0.002750 |
| i-Pentane | i-C₅ | 0.000002 | 0.000953 | 0.000858 |
| n-Pentane | n-C₅ | 0.000001 | 0.000826 | 0.000743 |
| c6-fraction | C6-fraction | 0.000000 | 0.000127 | 0.000114 |
| Carbon | | | | |
| Dioxide | CO₂ | 0.001403 | 0.004827 | 0.004484 |
| Nitrogen | N₂ | 0.028375 | 0.008596 | 0.010575 |

Example Conditions

Liquid Flow Rate (stream 24): 270 MMSCFD
Vapor Flow Rate (stream 20) to eductor 27: 30 MMSCFD
Eductor discharge flow rate (stream 25): 300 MMSCFD
Liquid pressure after pump 26, before eductor 27 (stream 24): 1350 psia
Eductor 27 discharge pressure: 1190 psia

A person skilled in the art, particularly one having the benefit of the teachings of this patent, will recognize many modifications and variations to the specific processes disclosed above. For example, a variety of temperatures and pressures may be used in accordance with the invention, depending on the overall design of the system and the composition of the PLNG. As discussed above, the specifically disclosed embodiments and examples should not be used to limit or restrict the scope of the invention, which is to be determined by the claims below and their equivalents.

What we claim is:

1. A process for converting a pressurized methane-rich vapor at a first pressure to a predetermined second pressure higher than the first pressure, comprising:
(a) providing the pressurized methane-rich vapor in a first container at the first pressure;
(b) withdrawing a pressurized liquid rich in methane from a second container;
(c) passing the pressurized liquid of step (b) to an eductor to drive the eductor and passing the vapor to the eductor, thereby liquefying the vapor and combining the liquefied vapor with the pressurized liquid;
(d) before or after step (c), pumping the pressurized liquid to a third pressure, higher than the second pressure; and then
(e) heating the pressurized liquid, thereby producing a vapor at the predetermined second pressure.

2. A process for converting a pressurized methane-rich vapor at a first pressure to a predetermined second pressure higher than the first pressure, comprising:
(a) providing the pressurized methane-rich vapor in a first container at the first pressure;
(b) withdrawing a pressurized first liquid rich in methane from a second container;
(c) pumping the pressurized first liquid to a third pressure, higher than the second pressure;
(d) passing the pressurized first liquid of step (c) to an eductor to drive the eductor;
(e) educting vapor from the first container and passing the vapor to the eductor, thereby liquefying the vapor and combining the liquefied vapor with the first liquid to form a second liquid at a pressure equal to or higher than the second pressure; and
(f) heating the second liquid, thereby producing a vapor at the predetermined second pressure.

3. A process for converting a pressurized methane-rich vapor at a first pressure to a vapor at a predetermined second pressure higher than the first pressure, comprising:
(a) providing the pressurized methane-rich vapor in a first container at the first pressure;
(b) withdrawing a pressurized first liquid rich in methane from a second container;
(c) passing the pressurized first liquid of step (b) to an eductor to drive the eductor;
(d) educting vapor from the first container and passing the vapor to the eductor, thereby liquefying the vapor and combining the liquefied vapor with the first liquid to form a second liquid at a third pressure;
(e) pumping the second liquid to substantially the second pressure; and
(f) heating the second liquid, thereby producing a vapor at the predetermined second pressure.

4. The process of claim 3 further comprising passing the vapor produced in step (f) to a pipeline.

5. The process of claim 3 wherein the second liquid is at or below its bubble point temperature.

6. A process for converting a pressurized methane-rich vapor at a first pressure to a predetermined second pressure higher than the first pressure, comprising:
(a) providing the pressurized methane-rich vapor in a container at the first pressure;
(b) withdrawing a pressurized first liquid rich in methane from the container;
(c) pumping the pressurized first liquid to a third pressure, higher than the second pressure;
(d) passing the pressurized first liquid of step (c) to an eductor to drive the eductor, the eductor producing a second liquid at the second pressure;
(e) educting vapor from the first container and passing the vapor to the eductor, thereby causing the vapor to liquefy and be combined with the first liquid to form the second liquid; and
(f) heating the second liquid, thereby producing a vapor at the predetermined second pressure.
